(19) United States
(12) Patent Application Publication
(10) Pub. No.: US 2019/0370890 A1
(43) Pub. Date: Dec. 5, 2019

(54) PARKING SPACE RENT-OUT APPARATUS, PARKING SPACE RENT-OUT SYSTEM, AND PARKING SPACE RENT-OUT METHOD

(71) Applicant: TOYOTA JIDOSHA KABUSHIKI KAISHA, Toyota-shi (JP)

(72) Inventors: Yoshihiro SAKAYANAGI, Mishima-shi (JP); Sui KURIHASHI, Sunto-gun (JP)

(73) Assignee: TOYOTA JIDOSHA KABUSHIKI KAISHA, Toyota-shi (JP)

(21) Appl. No.: 16/408,631

(22) Filed: May 10, 2019

(30) Foreign Application Priority Data
May 31, 2018 (JP) 2018-105204

(51) Int. Cl. G06Q 30/06; G08G 1/14; G06Q 50/30

(52) U.S. Cl. CPC G06Q 30/0645; G06Q 50/30; G08G 1/146

(57) ABSTRACT

A parking space rent-out apparatus 2 comprises a communication device 21 able to receive first information sent through a first terminal 3 and second information sent through a second terminal 4, and a control device 24. The control device is configured to calculate for each of the plurality of parking spaces an individual probability of vacancy based on the first information, calculate for each of the persons looking for parking an individual probability of usage, calculate a total probability of vacancy based on the individual probabilities of vacancy, calculate a total probability of usage based on the individual probabilities of usage, and accept a reservation of the group of private parking spaces for the predetermined time slot from a person looking for parking only if the total probability of vacancy minus the total probability of usage is equal to or more than a reference value.

### FIELD

The present invention relates to a parking space rent-out apparatus, parking space rent-out system, and parking space rent-out method.

### BACKGROUND

In the past, it has been known to provide information on the vacant states of parking spaces to persons looking for parking. In the parking space information system described in PTL 1, the vacant states of parking spaces are guessed based on information obtained through terminals moving together with drivers of parking vehicles.

### CITATION LIST

### Patent Literature

[PTL 1] Japanese Unexamined Patent Publication No. 2009-244960

### SUMMARY

### Technical Problem

In this regard, a parking space such as a home parking space in which a private car is parked is not constantly used by the vehicle of the owner of the parking space. For this reason, if the owner of the parking space could rent out the parking space to a person looking for parking while the space is vacant, the owner could obtain payment from the person looking for parking.

However, in the parking space management apparatus described in PTL 1, the owner of the parking space utilizing the parking space is not envisioned. Further, in a parking space utilized by an owner, typically, the number of cars that can be parked is smaller than a parking space designed especially for persons looking for parking. For this reason, if a person looking for parking who reserves a parking space fails to use the parking space, the income-generating rate of the parking space will greatly decline.

Therefore, an object of the present invention is to raise the operating efficiency of a parking space if renting out a parking space used by an owner to persons looking for parking when vacant.

### Solution to Problem

The summary of the present disclosure is as follows.

(1) A parking space rent-out apparatus for renting out a group of private parking spaces having a plurality of parking spaces within a predetermined range and with different owners to a person looking for parking, comprising a communication device able to receive first information sent through a first terminal owned by an owner and second information sent through a second terminal owned by the person looking for parking and a control device, wherein the control device is configured to calculate for each of the plurality of parking spaces an individual probability of vacancy which is a probability of the parking space not being utilized by its owner for a predetermined time slot based on the first information, calculate for each of the persons looking for parking an individual probability of usage which is a probability of the person looking for parking using the group of private parking spaces for the predetermined time slot based on the second information, calculate a total probability of vacancy which is a probability of “n” or more parking spaces not being used by their owners for the predetermined time slot based on the individual probabilities of vacancy, calculate a total probability of usage which is a probability of “n” or more persons looking for parking using the group of private parking spaces for the predetermined time slot based on the individual probabilities of usage, and accept a reservation of the group of private parking spaces for the predetermined time slot from a person looking for parking only if the total probability of vacancy minus the total probability of usage is equal to or more than a reference value, and a value of “n” includes a natural number of the number of persons looking for parking or less.

(2) The parking space rent-out apparatus described in above (1), wherein the value of “n” is set to the number of persons looking for parking.

(3) The parking space rent-out apparatus described in above (1), wherein the value of “n” is set to all natural numbers of the number of persons looking for parking or less, and the control device is configured to calculate for each of the values of “n” the total probability of vacancy and the total probability of usage and accept a reservation for the group of private parking spaces for the predetermined time slot from a person looking for parking only if the total probability of vacancy minus the total probability of usage is equal to or more than the reference value at all of the values of “n”.

(4) The parking space rent-out apparatus described in any one of above (1) to (3), wherein after a vehicle of a person looking for parking allowed to reserve the group of private parking spaces arrives in the vicinity of the group of private parking spaces, the control device is configured to notify the person looking for parking about one available parking space in the group of private parking spaces through the second terminal.

(5) The parking space rent-out apparatus described in any one of above (1) to (4), wherein if the group of private parking spaces is not available when a vehicle of a person looking for parking allowed to reserve the group of private parking spaces arrives in the vicinity of the group of private parking spaces, the control device is configured to guide the vehicle of the person looking for parking to a parking space other than the group of private parking spaces through the second terminal.

(6) The parking space rent-out apparatus described in any one of above (1) to (5), wherein if an owner's parking space is being utilized by a person looking for parking when a vehicle of the owner returns to the owner's parking space, the control device is configured to guide the vehicle of the owner to a parking space other than the owner's parking space through the first terminal.

(7) The parking space rent-out apparatus described in any one of above (1) to (6), wherein the first information includes a current position of a vehicle of the owner.

(8) The parking space rent-out apparatus described in any one of above (1) to (7), wherein the first information includes a destination of a vehicle of the owner.

(9) The parking space rent-out apparatus described in above (7) or (8), wherein if the vehicle of the owner is an electric vehicle, the first information includes a state of charge of a battery provided in the vehicle of the owner.

(10) The parking space rent-out apparatus described in any one of above (1) to (9), wherein the first information includes information relating to a schedule of the owner.

(11) The parking space rent-out apparatus described in any one of above (1) to (10), wherein the second information includes a current position of a vehicle of the person looking for parking.

(12) The parking space rent-out apparatus described in any one of above (1) to (11), wherein the second information includes a destination of a vehicle of the person looking for parking.

(13) The parking space rent-out apparatus described above (11) or (12), wherein if the vehicle of the person looking for parking is an electric vehicle, the second information includes a state of charge of a battery provided in the vehicle of the person looking for parking.

(14) The parking space rent-out apparatus described in any one of above (1) to (13), wherein the second information includes information relating to a schedule of the person looking for parking.

(15) The control device of a hybrid vehicle described in any one of above (1) to (10), A parking space rent-out system for renting out a group of private parking spaces having a plurality of parking spaces within a predetermined range and with different owners to a person looking for parking, comprising a first terminal able to send first information relating to an owner, a second terminal able to send second information relating to a person looking for parking, and a server, wherein the server comprises a communication device able to receive the first information and the second information and a control device, and the control device is configured to calculate for each of the plurality of parking spaces an individual probability of vacancy which is a probability of the parking space not being utilized by its owner for a predetermined time slot based on the first information, calculate for each of the persons looking for parking an individual probability of usage which is a probability of the person looking for parking using the group of private parking spaces for the predetermined time slot based on the second information, calculate a total probability of vacancy which is a probability of “n” or more parking spaces not being used by their owners for the predetermined time slot based on the individual probabilities of vacancy, calculate a total probability of usage which is a probability of “n” or more persons looking for parking using the group of private parking spaces for the predetermined time slot based on the individual probabilities of usage, and accept a reservation of the group of private parking spaces for the predetermined time slot from a person looking for parking only if the total probability of vacancy minus the total probability of usage is equal to or more than a reference value, and a value of “n” includes a natural number of the number of persons looking for parking or less.

(16) A parking space rent-out method for renting out a group of private parking spaces having a plurality of parking spaces within a predetermined range and with different owners to a person looking for parking, comprising receiving first information sent through a first terminal owned by an owner, receiving second information sent through a second terminal owned by the person looking for parking, calculating for each of the plurality of parking spaces an individual probability of vacancy which is a probability of the parking space not being utilized by its owner for a predetermined time slot based on the first information, calculating for each of the persons looking for parking an individual probability of usage which is a probability of the person looking for parking using the group of private parking spaces for the predetermined time slot based on the second information, calculating a total probability of vacancy which is a probability of “n” or more parking spaces not being used by their owners for the predetermined time slot based on the individual probabilities of vacancy, calculating a total probability of usage which is a probability of “n” or more persons looking for parking using the group of private parking spaces for the predetermined time slot based on the individual probabilities of usage, and accepting a reservation of the group of private parking spaces for the predetermined time slot from a person looking for parking only if the total probability of vacancy minus the total probability of usage is equal to or more than a reference value, the value of “n” including a natural number of the number of persons looking for parking or less.

### ADVANTAGEOUS EFFECTS OF INVENTION

According to the present invention, it is possible to raise the operating efficiency of a parking space if renting out a parking space used by an owner to persons looking for parking when vacant.

### BRIEF DESCRIPTION OF DRAWINGS

FIG. 1 is a schematic view of the configuration of a parking space rent-out system according to a first embodiment of the present invention.

FIG. 2 is a view showing one example of a group of private parking spaces.

FIG. 3A shows a specific example of comparing of the total probability of vacancy and the total probability of usage to judge whether reservation of a group of private parking spaces is accepted in the first embodiment.

FIG. 3B shows a specific example of comparing of the total probability of vacancy and the total probability of usage to judge whether reservation of a group of private parking spaces is accepted in the first embodiment.

FIG. 3C shows a specific example of comparing of the total probability of vacancy and the total probability of usage to judge whether reservation of a group of private parking spaces is accepted in the first embodiment.

FIG. 3D shows a specific example of comparing of the total probability of vacancy and the total probability of usage to judge whether reservation of a group of private parking spaces is accepted in the first embodiment.

FIG. 4 is a sequence diagram showing one example of operation of the parking space rent-out system according to the first embodiment of the present invention.

FIG. 5 is a flow chart showing a control routine of processing for calculation of an individual probability of vacancy in the first embodiment.

FIG. 6 is a flow chart showing a control routine of processing for calculation of an individual probability of usage in the first embodiment.

FIG. 7 is a flow chart showing a control routine of processing for judgment of a reservation in the first embodiment.

FIG. 8 is a flow chart showing a control routine of processing for judgment of a reservation in the first embodiment.

FIG. 9 is a flow chart showing a control routine of processing for guidance to a person reserving parking in a second embodiment.

FIG. 10 is a flow chart showing a control routine of processing for guidance to an owner in the second embodiment.

FIG. 11A shows a specific example of comparing of the total probability of vacancy and the total probability of usage to judge whether reservation of a group of private parking spaces is accepted in the third embodiment.

FIG. 11B shows a specific example of comparing of the total probability of vacancy and the total probability of usage to judge whether reservation of a group of private parking spaces is accepted in the third embodiment.

FIG. 11C shows a specific example of comparing of the total probability of vacancy and the total probability of usage to judge whether reservation of a group of private parking spaces is accepted in the third embodiment.

FIG. 12 is a flow chart showing a control routine of processing for judgment of a reservation in the third embodiment.

FIG. 13 is a flow chart showing a control routine of processing for judgment of a reservation in the third embodiment.

### DESCRIPTION OF EMBODIMENTS

Below, referring to the drawings, the parking space rent-out apparatus, parking space rent-out system, and parking space rent-out method according to embodiments of the present invention will be explained. Note that, in the following explanation, similar components will be assigned the same reference numerals.

### First Embodiment

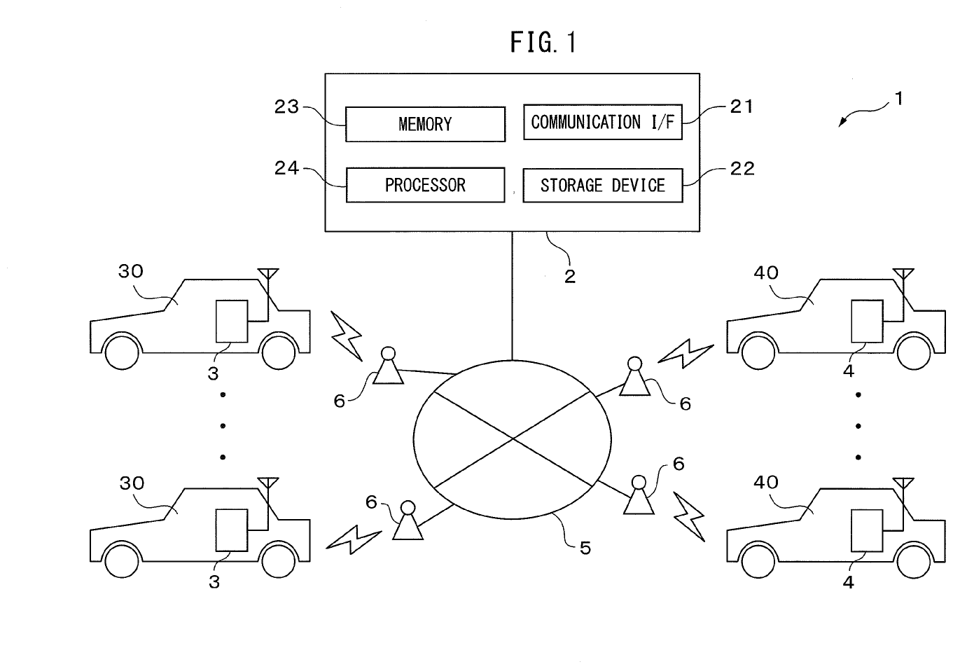

Below, referring to FIG. 1 to FIG. 8, a first embodiment of the present invention will be explained. FIG. 1 is a schematic view of the configuration of a parking space rent-out system according to the first embodiment of the present invention. The parking space rent-out system 1 is configured to rent out a group of private parking spaces including a plurality of parking spaces within a predetermined range and with different owners to a person looking for parking.

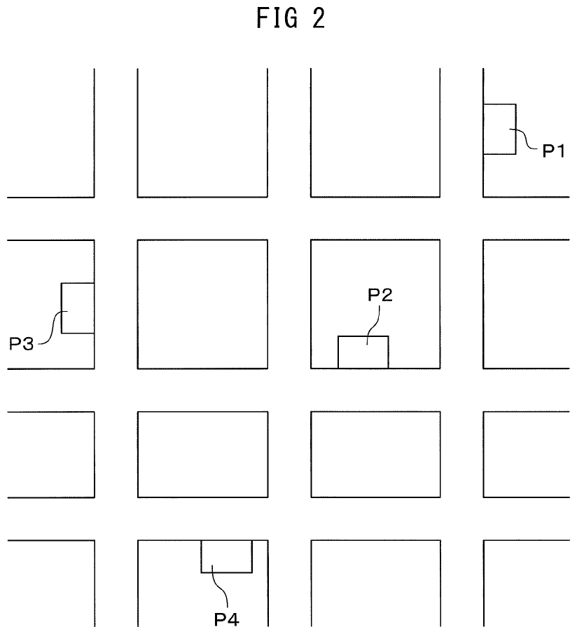

FIG. 2 is a view showing one example of a group of private parking spaces. In this example, the group of private parking spaces has four parking spaces P1 to P4. The parking spaces P1 to P4 are respectively owned by different owners and are positioned in a predetermined range. The “predetermined range” is for example a range of within several hundred meters from a predetermined position. The parking spaces P1 to P4 are utilized by their respective owners and for example are home parking spaces. Note that, a single owner may own two or more parking spaces.

As shown in FIG. 1, the parking space rent-out system 1 is provided with a server 2, first terminals 3, and second terminals 4. The owners of the parking spaces (below, simply referred to as “owners”) respectively have first terminals 3. The first terminal 3 can send first information relating to the owner. In the present embodiment, the first terminal 3 is a device able to communicate with the server 2 through a wireless base station 6 and communication network 5. The first terminal 3, for example, accesses the wireless base station 6 connected through a gateway to the communication network 5 to be connected to the communication network 5 through the wireless base station 6. Note that, the first terminal 3 may communicate with the server 2 through only the communication network 5 without going through the wireless base station 6.

The first terminal 3 is provided with a touch panel and microphone or other such input device and a display and speaker or other such output device. The first terminal 3 is for example a vehicle-mounted terminal provided at the vehicle 30 of the owner (for example, a navigation system). Note that, the first terminal 3 may be a mobile terminal moving together with the owner (for example, a smart phone, tablet terminal, personal computer, etc.). Further, the first terminal 3 may be a vehicle-mounted terminal and mobile terminal.

The persons looking for parking utilizing the group of private parking spaces respectively have second terminals 4. The second terminal 4 can send second information relating to the person looking for parking. In the present embodiment, the second terminal 4 is a device able to communicate with the server 2 through the wireless base station 6 and communication network 5. The second terminal 4, for example, accesses the wireless base station 6 connected through a gateway to the communication network 5 to be connected to the communication network 5 through the wireless base station 6. Note that, the second terminal 4 may communicate with the server 2 through only the communication network 5 without going through the wireless base station 6.

The second terminal 4 is provided with a touch panel and microphone or other such input device and a display and speaker or other such output device. The second terminal 4 is for example a vehicle-mounted terminal provided at the vehicle 40 of the person looking for parking (for example, a navigation system). Note that, the second terminal 4 may be a mobile terminal moving together with the person looking for parking (for example, a smart phone, tablet terminal, personal computer, etc.). Further, the second terminal 4 may be a vehicle-mounted terminal and mobile terminal.

The server 2 is provided with a communication interface 21, storage device 22, memory 23, and processor 24 and is, for example, connected through a gateway to the communication network 5. The communication interface 21, storage device 22, and memory 23 are connected through signal wires to the processor 24. Note that, the server 2 may be further provided with a keyboard and mouse or other such input device and a display or other such output device etc. The server 2 is one example of a parking space rent-out apparatus.

The communication interface 21 has an interface circuit for connecting the server 2 and the communication network 5. The communication interface 21 can receive the first information sent through the first terminals 3 and the second information sent through the second terminals 4. Further, in the present embodiment, the communication interface 21 can communicate with the first terminals 3 and the second terminals 4 through the communication network 5. The communication interface 21 receives various signals from the first terminals 3 and the second terminals 4 and transmits the received signals to the processor 24. Further, the communication interface 21 outputs commands from the processor 24 for the first terminals 3 and the second terminals 4 to the communication network 5. The communication interface 21 is one example of a communication device.

The storage device 22 is, for example, a hard disk drive (HDD), solid state drive (SDD), or optical storage medium. The storage device 22 stores various types of data and, for example, stores identification information of the group of private parking spaces, the positions of the parking spaces of the group of private parking spaces, map information, computer programs for the processor 24 to execute various processing, etc. Note that, the computer programs may be recorded on optical storage media or magnetic storage media or other such storage media and be distributed. The storage device 22 is one example of a memory device.

The memory 23, for example, has a semiconductor memory such as a random access memory (RAM). The memory 23 stores various types of data generated by the processor 24 performing various types of processing etc.

The processor 24 has one or more CPUs (central processing units) and their peripheral circuits and performs various types of processing. Note that, the processor 24 may further have processing circuits such as arithmetic logic units or numerical calculation units. The processor 24 is one example of a control device.

The parking space rent-out system 1 rents out parking spaces owned by owners to persons looking for parking in vacant time slots when the owners are not using the parking spaces. The vacant time slots differ for each parking space and change depending on the schedules of the owners. If the rent-out time slots of the parking spaces were individually set by the owners, the rent-out time slots would become shorter and the income-generating rates of the parking spaces would tend to fall. For example, if the individual probability of vacancy, which is the probability of a parking space not being utilized by an owner for a predetermined time slot, is 50%, an owner would tend not to rent out the parking space in those predetermined time slot.

In this regard, a person looking for parking will often not care about the exact position of a parking space so long as he is able to use a parking space near his destination. In other words, a person looking for parking may use any parking space among the group of private parking spaces near his destination. For example, if the individual probabilities of vacancy of the plurality of parking spaces P1 to P4 among the group of private parking spaces are respectively 50%, 50%, 40%, and 40%, the probability of one or more parking spaces being vacant becomes 91%. Therefore, the possibility is high that at least one person looking for parking can use the group of private parking spaces at a predetermined time slot.

Therefore, in the present embodiment, the processor 24 of the server 2 accepts a reservation of the group of private parking spaces from a person looking for parking and rents out the group of private parking spaces to the person looking for parking. By doing this, it is possible to raise the income-generating rates of the parking spaces compared with the case of parking spaces being individually rented out while considering the schedules of the owners.

Further, even if a person looking for parking reserves a group of private parking spaces for a predetermined time slot, the person looking for parking will not necessarily actually use the group of private parking spaces. That is, the individual probability of usage, which is the probability of a person looking for parking using the group of private parking spaces in the predetermined time slot, will not necessarily become 100%. For example, if other business arises, if a more convenient parking space is utilized, etc., the group of private parking spaces may not be used. Further, the time at which the vehicle 40 of a person looking for parking arrives at the group of private parking spaces may be delayed and the time slot of use of the group of private parking spaces may become shorter.

Therefore, in the present embodiment, the processor 24 compares the total probability of vacancy which is the probability of “n” or more of parking spaces not being utilized by their owners for a predetermined time slot and the total probability of usage which is the probability of “n” or more of persons looking for parking utilizing the group of private parking spaces in the predetermined time slot to judge whether the group of private parking spaces can be reserved for the predetermined time slot. Specifically, the processor 24 accepts a reservation of the group of private parking spaces for a predetermined time slot from person looking for parking only if the total probability of vacancy minus the total probability of usage is equal to or more than a reference value. The value of “n” includes a natural number of the number of persons looking for parking or less. The reference value is determined in advance. According to the above control, acceptance of reservations for the group of private parking spaces is determined considering the total probability of vacancy and the total probability of usage, so it is possible to keep utilization of parking spaces by owners and persons looking for parking from being hindered while raising the income-generating rates of the parking spaces of the group of private parking spaces.

In the present embodiment, the value of “n” used for calculating the total probability of vacancy and the total probability of usage is set to the number of persons looking for parking. For example, if there are two persons looking for parking, the value of “n” becomes 2.

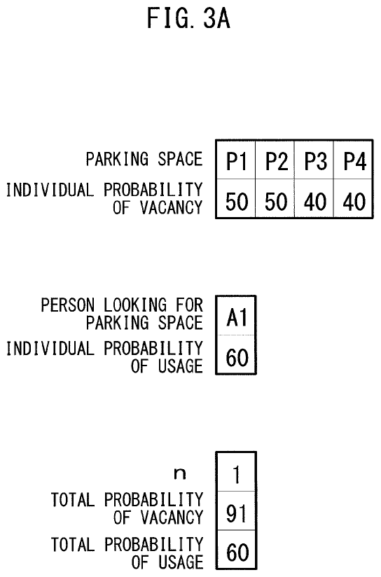

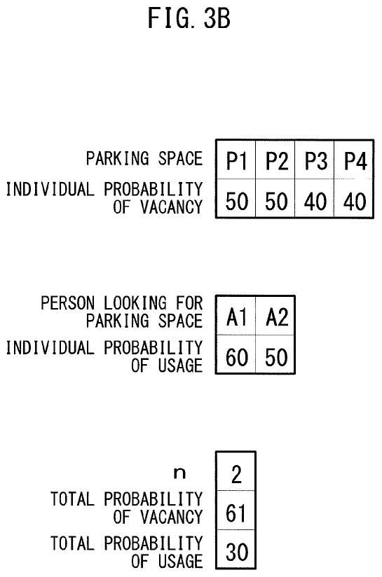

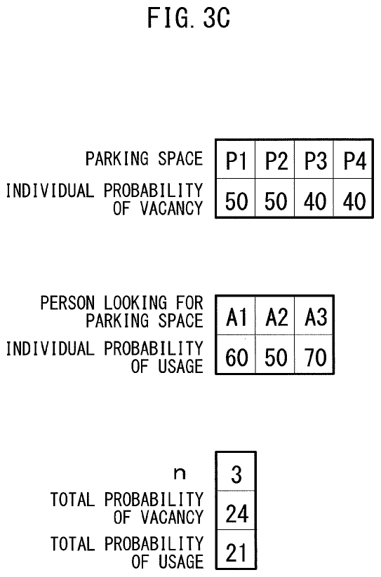

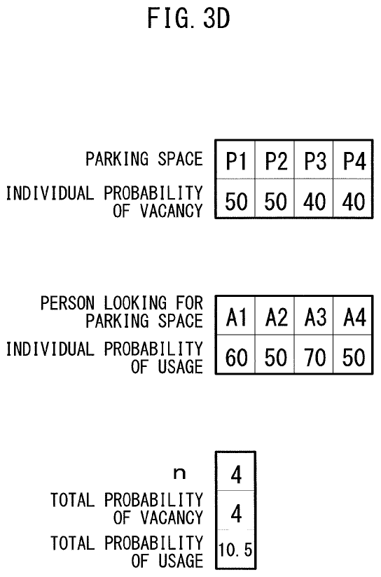

FIG. 3A to FIG. 3D show specific examples in the first embodiment of comparing the total probability of vacancy and the total probability of usage to judge whether a group of private parking spaces can be reserved. In the examples of FIG. 3A to FIG. 3D, in the same way as the example of FIG. 2, the group of private parking spaces includes four parking spaces P1 to P4. The processor 24 calculates the individual probabilities of vacancy based on the first information relating to the owners. In these examples, the individual probabilities of vacancy of the parking spaces P1 to P4 are respectively 50%, 50%, 40%, and 40%. Note that, in the examples of FIG. 3A to FIG. 3D, to simplify the explanation, it is assumed that the individual probabilities of vacancy are maintained constant.

In the example of FIG. 3A, first, a person looking for parking A1 requests to reserve the group of private parking spaces for a predetermined time slot. The processor 24 calculates the individual probability of usage for the person looking for parking A1 based on the second information relating to the person looking for parking A1. In this example, the individual probability of usage for the person looking for parking A1 is 60%.

In the example of FIG. 3A, there is a single person looking for parking, so the value of “n” used for calculating the total probability of vacancy and the total probability of usage becomes 1. The processor 24 calculates the total probability of vacancy based on the individual probabilities of vacancy. In this example, the total probability of vacancy when “n” is 1, that is, the probability of one or more parking spaces not being utilized by their owners for a predetermined time slot, is 91%.

Further, the processor 24 calculates the total probability of usage based on the individual probabilities of usage. In this example, the total probability of usage when “n” is 1, that is, the probability of one or more persons looking for parking utilizing the group of private parking spaces for a predetermined time slot, is 60%.

Therefore, when “n” is 1, the total probability of vacancy (91%) is higher than the total probability of usage (60%). In the examples of FIG. 3A to FIG. 3D, the reference value for judging whether the group of private parking spaces can be reserved is set to zero. That is, if the total probability of vacancy is equal to or more than the total probability of usage, reservation of the group of private parking spaces is accepted. For this reason, reservation of the group of private parking spaces is accepted from the person looking for parking A1.

In the example of FIG. 3B, a person looking for parking A1 reserves the group of private parking spaces, then a person looking for parking A2 requests to reserve the group of private parking spaces for a predetermined time slot. The person looking for parking A1 has still not utilized the group of private parking spaces. Note that, in the examples of FIG. 3A to FIG. 3D, to simplify the explanation, it is assumed that the individual probabilities of usage of the persons looking for parking are maintained constant. The processor 24 calculates the individual probability of usage for the person looking for parking A2 based on the second information relating to the person looking for parking A2. In this example, the individual probability of usage for the person looking for parking A2 is 50%.

In the example of FIG. 3B, there are two persons looking for parking, so the value of “n” used for calculating the total probability of vacancy and the total probability of usage becomes 2. In this example, the total probability of vacancy when “n” is 2, that is, the probability of two or more parking spaces not being utilized by their owners for a predetermined time slot, is 61%. Further, the total probability of usage when “n” is 2, that is, the probability of two or more persons looking for parking utilizing the group of private parking spaces for a predetermined time slot, is 30%. Therefore, when “n” is 2, the total probability of vacancy (61%) is higher than the total probability of usage (30%). For this reason, reservation of the group of private parking spaces is accepted from the person looking for parking A2.

In the example of FIG. 3C, persons looking for parking A1 and A2 reserve the group of private parking spaces, then a person looking for parking A3 requests to reserve the group of private parking spaces for a predetermined time slot. The persons looking for parking A1 and A2 still are not utilizing the group of private parking spaces. The processor 24 calculates the individual probability of usage for the person looking for parking A3 based on the second information relating to the person looking for parking A3. In this example, the individual probability for usage of the person looking for parking A3 is 70%.

In the example of FIG. 3C, there are three persons looking for parking, so the value of “n” used for calculating the total probability of vacancy and the total probability of usage becomes 3. In this example, the total probability of vacancy when “n” is 3, that is, the probability of three or more parking spaces not being utilized by their owners for a predetermined time slot, is 24%. Further, the total probability of usage when “n” is 3, that is, the probability of three or more persons looking for parking utilizing the group of private parking spaces for a predetermined time slot, is 21%. Therefore, when “n” is 3, the total probability of vacancy (24%) is higher than the total probability of usage (21%). For this reason, reservation of the group of private parking spaces is accepted from the person looking for parking A3.

In the example of FIG. 3D, persons looking for parking A1, A2, and A3 reserve the group of private parking spaces, then a person looking for parking A4 requests to reserve the group of private parking spaces for a predetermined time slot. The persons looking for parking A1, A2, and A3 have still not utilized the group of private parking spaces. The processor 24 calculates the individual probability of usage for the person looking for parking A4 based on the second information relating to the person looking for parking A4. In this example, the individual probability of usage for the person looking for parking A4 is 50%.

In the example of FIG. 3D, there are four persons looking for parking, so the value of “n” used for calculating the total probability of vacancy and the total probability of usage becomes 4. In this example, the total probability of vacancy when “n” is 4, that is, the probability of four or more parking spaces not being utilized by their owners for a predetermined time slot, is 4%. Further, the total probability of usage when “n” is 4, that is, the probability of four or more persons looking for parking utilizing the group of private parking spaces for a predetermined time slot, is 10.5%. Therefore, when “n” is 4, the total probability of vacancy (4%) is lower than the total probability of usage (10.5%). For this reason, reservation of the group of private parking spaces by the person looking for parking A4 is rejected.

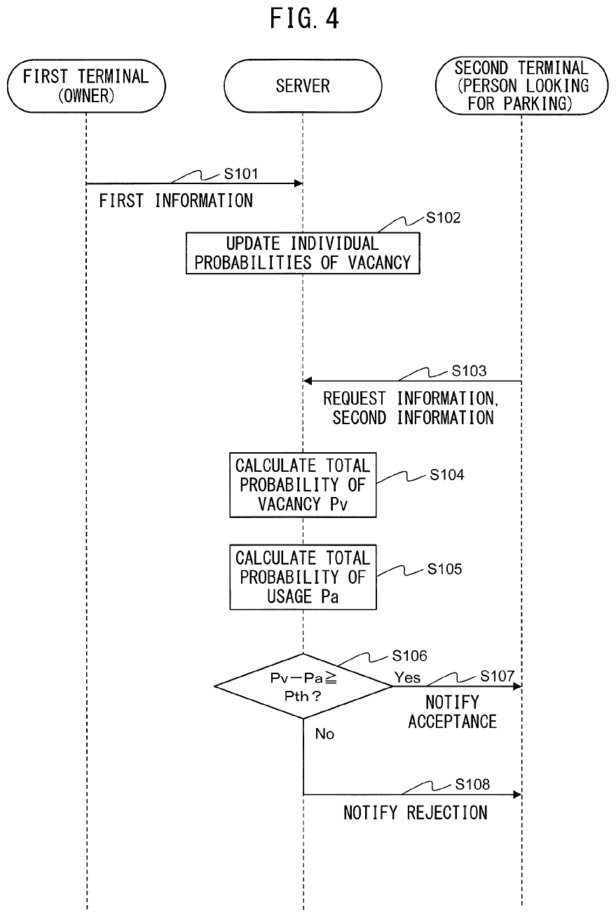

FIG. 4 is a sequence diagram showing one example of the operation of the parking space rent-out system 1 according to the first embodiment of the present invention. Note that, in the sequence diagram, communication between the server 2 and a first terminal 3 and communication between the server 2 and a second terminal 4 are performed through the communication interface 21 of the server 2 and the communication network 5. Further, the processing by the server 2 is performed by the processor 24 of the server 2.

The plurality of first terminals 3 respectively periodically transmit first information to the server 2 (step S101). When the server 2 receives the first information from a first terminal 3, it updates the individual probability of vacancy for each time slot for the parking space of the owner owning the first terminal 3 (step S102).

When a person looking for parking desires to reserve the group of private parking spaces, the person operates the second terminal 4 and inputs request information for reserving the group of private parking spaces to the second terminal 4. If request information is input to the second terminal 4, the second terminal 4 sends the request information and the second information to the server 2 (step S103). The request information includes identification information of the group of private parking spaces at which it is desired to park and the time slot during which it is desired to park there (desired time slot) etc. For example, if a person looking for parking inputs the desired parking location to the second terminal 4, the second terminal 4 selects the group of private parking spaces closest to the desired parking location. Note that, a person looking for parking may directly select a desired group of private parking spaces on the second terminal 4 or may select a desired group of private parking spaces from candidates of groups of private parking spaces displayed on the second terminal 4.

When the server 2 receives the request information and the second information from a second terminal 4, it calculates the total probability of vacancy Pv based on the individual probabilities of vacancy when a predetermined time slot is the desired time slot. In the example of FIG. 4, there is one person looking for parking. For this reason, the server 2 calculates the total probability of vacancy Pv when “n” is 1 and a predetermined time slot is the desired time (step S104). Further, the server 2 calculates the individual probability of usage when “n” is 1 and a predetermined time slot is the desired time slot based on the second information and calculates the total probability of usage Pa when the predetermined number is 1 and a predetermined time slot is the desired time slot based on this individual probability of usage (step S105). Note that, when there is a single person looking for parking, the individual probability of usage and the total probability of usage are equal.

Next, the server 2 judges whether the total probability of vacancy Pv minus the total probability of usage Pa is equal to or more than a reference value Pth (step S106). If the total probability of vacancy Pv minus the total probability of usage Pa is equal to or more than the reference value Pth, the server 2 accepts reservation of the group of private parking spaces at the desired time slot from the person looking for parking. Specifically, the server 2 sends a notification of acceptance of reservation to the second terminal 4 (step S107). As a result, the person looking for parking is notified of acceptance of the reservation through the second terminal 4.

On the other hand, if the total probability of vacancy Pv minus the total probability of usage Pa is less than the reference value Pth, the server 2 rejects the reservation of the group of private parking spaces at the desired time slot. Specifically, the server 2 sends a notification of rejection of reservation to the second terminal 4 (step S108). As a result, the person looking for parking is notified of rejection of the reservation through the second terminal 4.

<Processing for Calculation of Individual Probability of Vacancy>

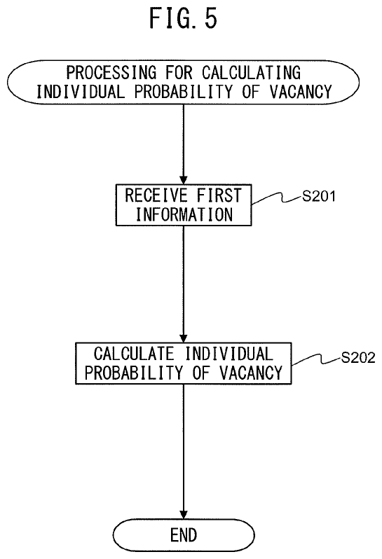

Below, the processing performed by the server 2 when a group of private parking spaces are rented out to persons looking for parking will be explained. FIG. 5 is a flow chart showing the control routine of processing for calculating an individual probability of vacancy in the first embodiment. The present control routine is repeatedly executed at predetermined intervals by the processor 24 of the server 2 for each parking space included in the group of private parking spaces.

First, at step S201, the processor 24 receives the first information from a first terminal 3 through the communication network 5 and communication interface 21. For example, the first information includes the current position of the vehicle 30 of an owner of a parking space. The current position of the vehicle 30 of the owner (for example, the latitude and longitude of the vehicle 30 of the owner) is, for example, detected by a GPS receiver provided at the first terminal 3 or a device able to communicate with the first terminal 3.

Note that, the first information may include the destination of the vehicle 30 of the owner. The destination of the vehicle 30 of the owner is input by the owner to the first terminal 3 or a device able to communicate with the first terminal 3. Further, the destination of the vehicle 30 of the owner may be estimated from a driving log etc., of the vehicle 30 of the owner stored in the first terminal 3 or a device able to communicate with the first terminal 3. Further, if the vehicle 30 of the owner is an electric vehicle (EV), the first information may include a state of charge (SOC) of a battery provided in the vehicle 30 of the owner.

Further, the first information may include information relating to the schedule of the owner. For example, the information relating to the schedule of the owner may be request information for reserving lodging facilities (hotels, inns, etc.), transportation systems (ferries etc.), restaurants, hospitals, beauty parlors, car servicing, parking spaces, etc. These reservations can be managed by the server 2 or a server able to communicate with the server 2 and separate from the server 2. The processor 24 can obtain the states of these reservations.

Further, the information relating to the schedule of the owner may be information uploaded through the first terminal 3 to the cloud server by utilization of a social networking service (SNS) etc. In this case, the processor 24 receives the first information from the cloud server through the communication network 5 and communication interface 21.

Next, at step S202, the processor 24 calculates the individual probability of vacancy for each time slot based on the first information. The calculated individual probability of vacancy is for example stored in the storage device 22. The processor 24 repeatedly calculates the individual probability of vacancy to update the individual probability of vacancy.

For example, the processor 24 estimates the time when the vehicle 30 of the owner will return to the owner's parking space (below, referred to as the “return time”) based on at least one of the current position and destination of the vehicle 30 of the owner and raises the individual probability of vacancy at the time slot from the current time to the return time compared to other time slots. Further, if the vehicle 30 of the owner is an electric vehicle, the processor 24 may correct the return time based on the SOC of the battery provided at the vehicle 30 of the owner. In this case, if it is estimated that the vehicle 30 of the owner requires charging of the battery before returning to the owner's parking space, the return time will be pushed back further considering the charging time of the battery.

Further, the processor 24 may estimate the time slot in which the parking space will not be utilized by the vehicle 30 of the owner based on information of the schedule of the owner and raise the individual probability of vacancy at the time slot compared to other time slots. For example, the processor 24 raises the individual probability of vacancy at the reserved time slot included in predetermined reservation request information. Further, if it is estimated that the owner will be drinking based on information relating to the schedule of the owner (for example, reservation of a meal plan including drinking, photos and comments suggesting drinking, etc.) and the vehicle 30 of the owner is away from the owner's parking space, the processor 24 may raise the individual probability of vacancy from the estimated time of start of drinking to the next morning compared to other time slots. After step S202, the present control routine ends.

<Processing for Calculation of Individual Probability of Usage>

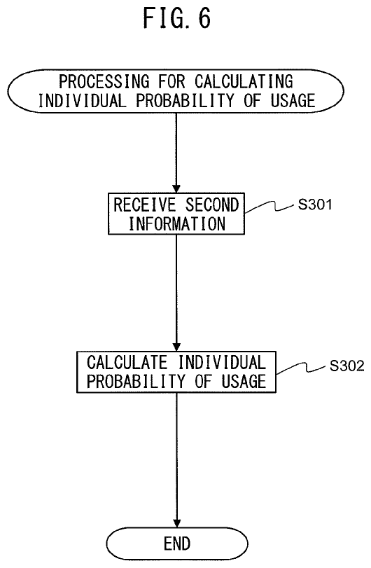

FIG. 6 is a flow chart showing a control routine of processing for calculating an individual probability of usage in the first embodiment. The present control routine is repeatedly executed at predetermined intervals by the processor 24 of the server 2 for each person reserving parking. Note that, a “person reserving parking” means a person looking for parking whose reservation of the group of private parking spaces has been accepted and who has not yet finished using the group of private parking spaces. The processor 24 judges whether a person looking for parking has finished using the group of private parking spaces for example based on the history of the current position of the vehicle 40 of the person looking for parking etc.

First, at step S301, the processor 24 receives second information through the communication network 5 and communication interface 21 from a second terminal 4. For example, the second information includes the current position of the vehicle 40 of the person reserving parking. The current position of the vehicle 40 of the person reserving parking (for example, the latitude and longitude of the vehicle 40 of the person reserving parking) is, for example, detected by a GPS receiver provided at the second terminal 4 or a device able to communicate with the second terminal 4.

Note that, the second information may include the destination of the vehicle 40 of the person reserving parking. The destination of the vehicle 40 of the person reserving parking is input to the second terminal 4 or a device able to communicate with the second terminal 4 by the person reserving parking. Further, the destination of the vehicle 40 of the person reserving parking may be estimated from the driving log etc., of the vehicle 40 of the person reserving parking stored in the second terminal 4 or a device able to communicate with the second terminal 4. Further, if the vehicle 40 of the person reserving parking is an electric vehicle (EV), the second information may include the SOC of the battery provided at the vehicle 40 of the person reserving parking.

Further, the second information may include information relating to the schedule of the person reserving parking. For example, the information relating to the schedule of the person reserving parking may be request information for reserving lodging facilities (hotels, inns, etc.), transportation systems (ferries etc.), restaurants, hospitals, beauty parlors, car servicing, etc. These reservations can be managed by the server 2 or a server able to communicate with the server 2 and separate from the server 2. The processor 24 can obtain the states of these reservations.

Further, the information relating to the schedule of the person reserving parking may be information uploaded through the second terminal 4 to a cloud server by utilization of a social networking service (SNS) etc. In this case, the processor 24 receives the second information from the cloud server through the communication network 5 and communication interface 21.

Next, at step S302, the processor 24 calculates the individual probability of usage for each time slot based on the second information. The calculated individual probability of usage is for example stored in the storage device 22. The processor 24 repeatedly calculates the individual probability of usage to update the individual probability of usage.

For example, the processor 24 estimates the time when the vehicle 40 of the person reserving parking will arrive at the group of private parking spaces (below, referred to as the “arrival time”) based on at least one of the current position and destination of the vehicle 40 of the person reserving parking and lowers the individual probability of usage at the time slot from the current time to the arrival time compared to other time slots. Further, if the vehicle 40 of the person reserving parking is an electric vehicle, the processor 24 may correct the arrival time based on the SOC of the battery provided at the vehicle 40 of the person reserving parking. In this case, if it is estimated that the vehicle 40 of the person reserving parking requires charging of the battery before arriving at the group of private parking spaces, the arrival time will be pushed back further considering the charging time of the battery.

Further, the processor 24 may estimate the time slot in which the group of private parking spaces will not be utilized by a vehicle 40 of a person reserving parking based on information of the schedule of the person reserving parking and lower the individual probability of usage at the time slot compared to other time slots. For example, the processor 24 lowers the individual probability of usage at the reserved time slot included in the reservation request information compared with other time slots if a reservation is made by the person reserving parking for a location far from the group of private parking spaces to be utilized by the person reserving parking. Further, if it is estimated that the person reserving parking will be drinking at a location far from the group of private parking spaces to be utilized by the person reserving parking based on information relating to the schedule of the person reserving parking (for example, reservation of a meal plan including drinking, photos and comments suggesting drinking, etc.), the processor 24 may lower the individual probability of usage from the estimated time of start of drinking to the next morning compared to other time slots.

Further, the processor 24 may estimate the time slot in which the group of private parking spaces will reliably be utilized by the vehicle 40 of the person reserving parking based on information of the schedule of the person reserving parking and raise the individual probability of usage at the time slot compared to other time slots. For example, the processor 24 raises the individual probability of usage at the reserved time slot included in the reservation request information compared with other time slots if a reservation relating to a location in the vicinity of the group of private parking spaces to be utilized by the person reserving parking is made by the person reserving parking. Further, if it is estimated that the person reserving parking will be drinking at the location in the vicinity of the group of private parking spaces to be utilized by the person reserving parking based on information relating to the schedule of the person reserving parking (for example, reservation of a meal plan including drinking, photos and comments suggesting drinking, etc.), the processor 24 may raise the individual probability of usage from the estimated time of start of drinking to the next morning compared to other time slots. After step S302, the present control routine ends.

<Processing for Judgment of Reservation>

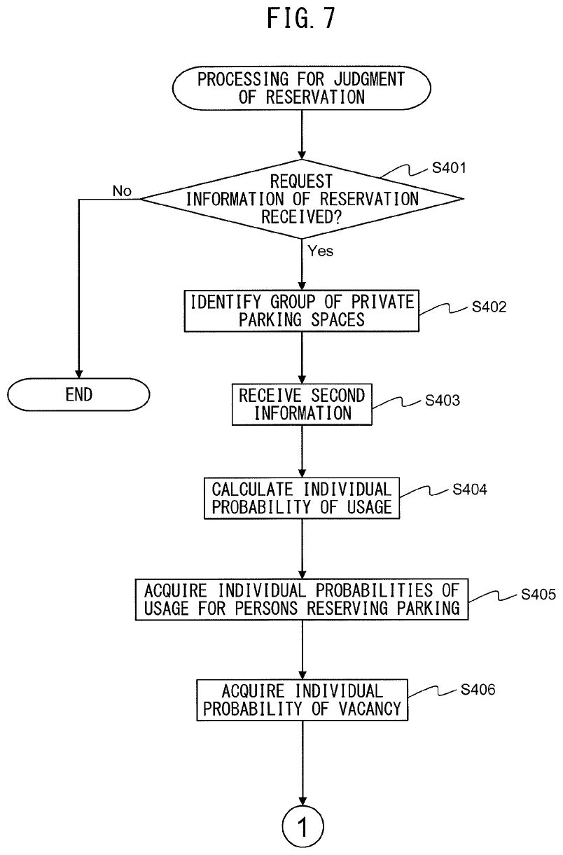

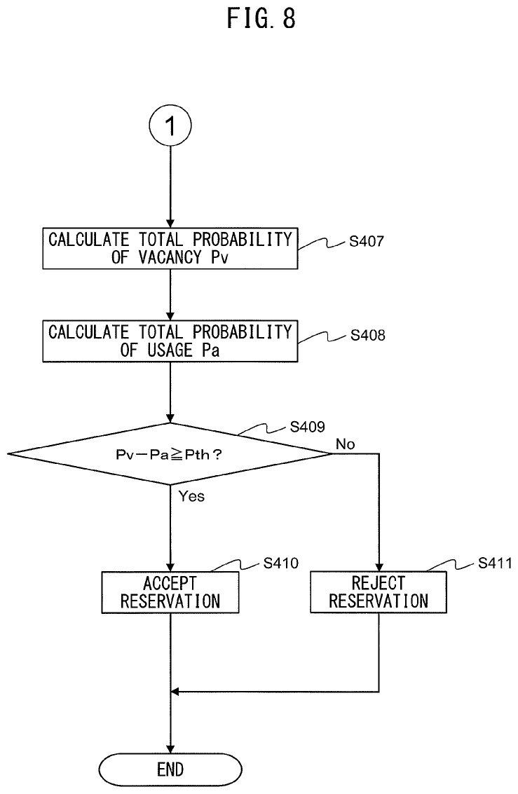

FIG. 7 and FIG. 8 are flow charts showing a control routine of processing for judgment of a reservation in the first embodiment. The present control routine is repeatedly executed by the processor 24 of the server 2.

First, at step S401, the processor 24 judges whether it has received request information for reserving a group of private parking spaces from a second terminal 4 through the communication network 5 and communication interface 21. If it is judged that no request information has been received, the present control routine ends. On the other hand, if it is judged that request information has been received, the present control routine proceeds to step S402.

At step S402, the processor 24 identifies the group of private parking spaces designated by the person looking for parking based on the request information (specifically, the identification information of the group of private parking spaces). Next, at step S403, the processor 24 receives second information from the second terminal 4. The content of the second information received at step S403 is similar to the second information received at step S301 of FIG. 6.

Next, at step S404, based on the second information received at step S403, the processor 24 calculates the individual probability of usage at a desired time slot for the person looking for parking sending the request information through the second terminal 4, that is, the person looking for parking for which acceptance of a reservation is being judged. The desired time slot is included in the request information.

Next, at step S405, the processor 24 acquires the individual probability of usage at the desired time slot for the person reserving parking whose reservation of parking in the group of private parking spaces identified at step S402 is accepted. The individual probability of usage for the person reserving parking is calculated at step S302 of FIG. 6. Note that, if there are no persons reserving parking, step S404 is omitted.

Next, at step S406, the processor 24 acquires the individual probability of vacancy at the desired time slot for a parking space included in the group of private parking spaces identified at step S402. The individual probability of vacancy is calculated at step S202 of FIG. 5.

Next, at step S407, the processor 24 calculates the total probability of vacancy Pv when “n” is the number of persons looking for parking and a predetermined time slot is the desired time slot. That is, the processor 24 calculates the probability of the number of parking spaces equal to or greater than the number of persons looking for parking not being utilized by the owners at the desired time slot. For example, if there are two persons reserving parking when request information is sent from a person looking for parking, the number of persons looking for parking becomes 3. Note that, when the number of persons looking for parking is larger than the number of parking spaces in the group of private parking spaces, the total probability of vacancy Pv becomes 0%.

Next, at step S408, the processor 24 calculates the total probability of usage Pa when “n” is the number of persons looking for parking and a predetermined time slot is the desired time slot. That is, the processor 24 calculates the probability of all of the persons looking for parking utilizing the group of private parking spaces in the desired time slot.

Next, at step S409, the processor 24 judges whether the total probability of vacancy Pv minus the total probability of usage Pa is equal to or more than a reference value Pth. The reference value Pth is determined in advance and is, for example, zero. If the reference value Pth is zero, at step S409, the processor 24 judges whether the total probability of vacancy Pv is equal to or more than the total probability of usage Pa.

If at step S409 it is judged that the total probability of vacancy Pv minus the total probability of usage Pa is less than the reference value Pth, the present control routine proceeds to step S411. At step S411, the processor 24 rejects the reservation of the group of private parking spaces for the person looking for parking. Specifically, the processor 24 sends a notification of rejection through the communication interface 21 and communication network 5 to the second terminal 4 of the person looking for parking.

On the other hand, if at step S409 it is judged that the total probability of vacancy Pv minus the total probability of usage Pa is equal to or more than the reference value Pth, the present control routine proceeds to step S410. At step S410, the processor 24 accepts the reservation of the group of private parking spaces from the person looking for parking. Specifically, the processor 2 sends a notification of acceptance through the communication interface 21 and communication network 5 to the second terminal 4 of the person looking for parking. After step S410, the present control routine ends.

### Second Embodiment

The parking space rent-out apparatus, parking space rent-out system, and parking space rent-out method according to the second embodiment are basically similar to the parking space rent-out apparatus, parking space rent-out system, and parking space rent-out method according to the first embodiment except for the points explained below. For this reason, below, the second embodiment of the present invention will be explained centered about parts different from the first embodiment.

If reservation of the group of private parking spaces is accepted from a person looking for parking, since the vacant states of the parking spaces in the group of private parking spaces change, a parking space which the person looking for parking can utilize will not be certain until just before utilizing the parking space. For this reason, if a person looking for parking tries to find an available parking space on his or her own, it will take time until finding the available parking space and the person looking for parking is liable to be unable to utilize the parking space in the desired time slot. Further, if a parking space which was vacant at the point of time when reservation of the group of private parking spaces was accepted is notified to a person looking for parking, that parking space is liable to be utilized by the owner or another person looking for parking before the person looking for parking arrives at the parking space.

Therefore, in the second embodiment, the processor 24 notifies a person looking for parking of one available parking space in the group of private parking spaces through the second terminal 4 after the vehicle of the person looking for parking whose reservation of the group of private parking spaces is accepted, that is, a person reserving parking, arrives at the vicinity of the group of private parking spaces. By doing this, a person reserving parking can easily find the available parking space. For this reason, it is possible to promote rent-out of parking spaces and in turn possible to further raise the income-generating rates of parking spaces.

Further, even if it is judged whether a group of private parking spaces can be reserved considering the total probability of vacancy and the total probability of usage, an owner and person reserving parking will not necessarily be able to utilize the parking space in the desired time slot. Therefore, in the second embodiment, if the group of private parking spaces is not available when the vehicle 40 of the person reserving parking arrives the vicinity of the group of private parking spaces, the processor 24 guides the vehicle 40 of the person reserving parking through the second terminal 4 to a parking space other than the group of private parking spaces. By doing this, it is possible to reliably provide an available parking space to a person reserving parking.

Further, if the owner's parking space is being utilized by a person looking for parking when the vehicle 30 of the owner returns to the owner's parking space, the processor 24 guides the vehicle 30 of the owner to a parking space other than the owner's parking space through the first terminal 3. By doing this, it is possible to reliably provide an available parking space to the owner.

<Processing for Guidance to Person Reserving Parking>

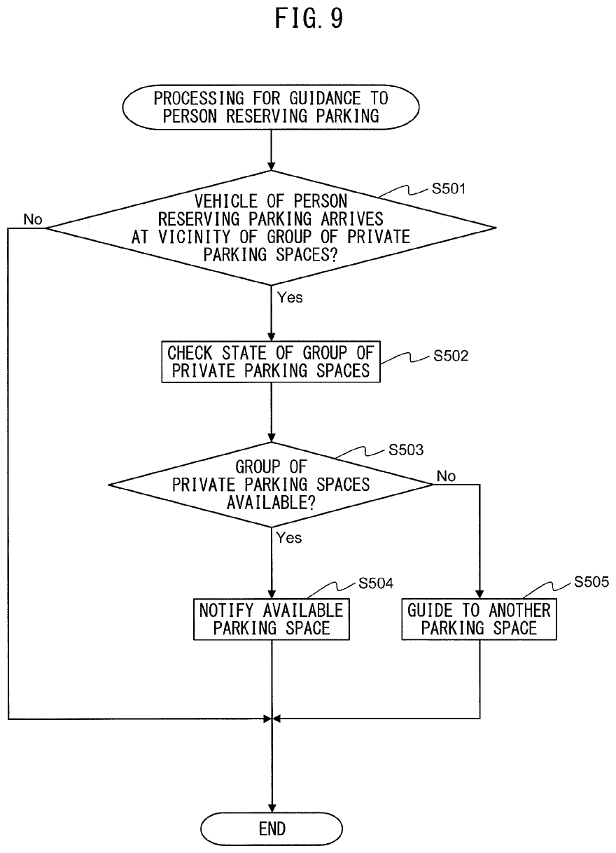

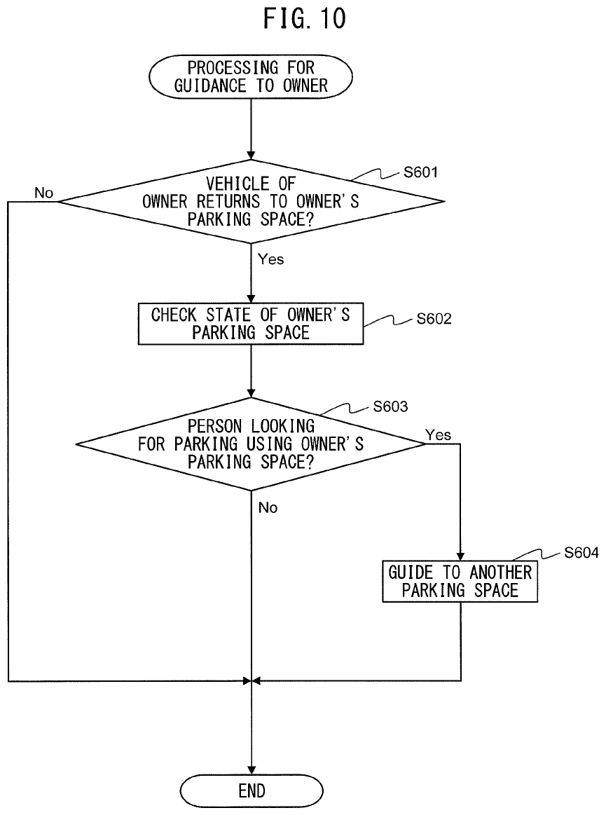

In the second embodiment, in addition to the control routine of FIG. 5 to FIG. 8, the control routine of FIG. 9 and FIG. 10 is performed by the server 2. FIG. 9 is a flow chart showing a control routine of processing for guidance to a person reserving parking in the second embodiment. The present control routine is repeatedly executed by the processor 24 of the server 2 for each person reserving parking.

First, at step S501, the processor 24 judges whether the vehicle 40 of the person reserving parking has arrived at the vicinity of the group of private parking spaces. The processor 24 performs this judgment, for example, based on the current position of the vehicle 40 of the person reserving parking and judges that the vehicle 40 of the person reserving parking has arrived at the vicinity of the group of private parking spaces when the distance from the vehicle 40 of the person reserving parking to the group of private parking spaces becomes equal to or less than a predetermined distance. Note that, the position of the group of private parking spaces is set to a predetermined position within the range of the group of private parking spaces. If at step S501 it is judged that the vehicle 40 of the person reserving parking has not arrived at the vicinity of the group of private parking spaces, the present control routine ends.

On the other hand, if at step S501 it is judged the vehicle 40 of the person reserving parking has arrived at the vicinity of the group of private parking spaces, the present control routine proceeds to step S502. At step S502, the processor 24 checks the state of the group of private parking spaces. Specifically, the processor 24 estimates the vacant states of the parking spaces of the group of private parking spaces based on the current positions of the vehicles 30 of the owners, the current positions of the vehicles 40 of the persons reserving parking, etc.

Next, at step S503, the processor 24 judges whether the group of private parking spaces is available. If it is judged that the group of private parking spaces is available, that is, if one or more parking spaces in the group of private parking spaces is vacant, the present control routine proceeds to step S504.

At step S504, the processor 24 notifies one available parking space to the person reserving parking. Specifically, the processor 24 sends information of the available parking space (for example, the position, image, etc. of the parking space) through the communication interface 21 and communication network 5 to the second terminal 4. As a result, the person reserving parking is notified of one available parking space through the second terminal 4. After step S504, the present control routine ends.

On the other hand, if at step S503 it is judged that the group of private parking spaces is unavailable, that is, if all of the parking spaces in the group of private parking spaces are being utilized, the present control routine proceeds to step S505. At step S505, the processor 24 guides the vehicle 40 of the person reserving parking to another parking space. The other parking space is a parking space outside this group of private parking spaces near that group of private parking spaces. For example, it is a metered parking space designed especially for persons looking for parking.

Specifically, the processor 24 sends route information up to the other parking space through the communication interface 21 and communication network 5 to the second terminal 4. As a result, the route to the other parking space is displayed on the second terminal 4. Further, the second terminal 4 may guide the vehicle 40 of the person reserving parking by voice based on the route information. Further, if the vehicle 40 of the person reserving parking is an automated driving vehicle, the driving actuator may be controlled so that the vehicle 40 of the person reserving parking reaches the other parking space based on the route information sent to the second terminal 4. After step S505, the present control routine ends.

Note that, at step S504, in the same way as step S505, the processor 24 may guide the vehicle 40 of the person reserving parking to one available parking space. Further, if the person reserving parking utilizes the parking space in the group of private parking spaces, the processor 24 may process payment between the person reserving parking and the owner of the parking space. In this case, for example, the processor 24 performs processing for withdrawing money from the designated account of the person reserving parking and processing for depositing money in the designated account of the owner of the parking space. Further, if an addition charge is necessary for the vehicle 40 of the person reserving parking to utilize another parking space, the manager of the server 2 may bear the additional charge. In this case, for example, the processor 24 performs processing for depositing money in the designated account of the persons reserving parking.

<Processing for Guidance to Owner>

FIG. 10 is a flow chart showing a control routine of processing for guidance to an owner in the second embodiment. The present control routine is repeatedly executed by the processor 24 of the server 2 for each owner of a parking space.

First, at step S501, the processor 24 judges whether the vehicle 30 of the owner has returned to the owner's parking space. The processor 24 for example judges this based on the current position of the vehicle 30 of the owner. It judges that the vehicle 30 of the owner has returned to the owner's parking space when the distance from the vehicle 30 of the owner to the owner's parking space has become equal to or less than a predetermined distance. If at step S601 it is judged that the vehicle 30 of the owner has not returned to the owner's parking space, the present control routine ends.

On the other hand, if at step S601 it is judged that the vehicle 30 of the owner has returned to the owner's parking space, the present control routine proceeds to step S602. At step S602, the processor 24 checks the state of the owner's parking space. Specifically, the processor 24 estimates the vacant state of the owner's parking space based on the current position of the vehicle 40 of the person looking for parking etc.

Next, at step S603, the processor 24 judges whether a person looking for parking is utilizing the owner's parking space. If it is judged that a person looking for parking is not utilizing the owner's parking space, that is, if the owner's parking space is vacant, the present control routine ends.

On the other hand, if at step S603 it is judged that a person looking for parking is utilizing the owner's parking space, the present control routine proceeds to step S604. At step S604, in the same way as step S505 of FIG. 9, the processor 24 guides the vehicle 30 of the owner to another parking space. The other parking space is a parking space other than the owner's parking space near the owner's parking space, for example, is another owner's parking space or a metered parking space designed for persons looking for parking. After step S604, the present control routine ends.

Note that, if the vehicle 30 of the owner utilizes another parking space, the manager of the server 2 may bear the charge for using the other parking space. In this case, for example, the processor 24 deposits money in the designated account of the owner.

### Third Embodiment

The parking space rent-out apparatus, parking space rent-out system, and parking space rent-out method according to the third embodiment are basically similar to the parking space rent-out apparatus, parking space rent-out system, and parking space rent-out method according to the first embodiment except for the points explained below. For this reason, below, the third embodiment of the present invention will be explained centered about parts different from the first embodiment.

Even if the total probability of vacancy is higher than the total probability of usage when the value of “n” is the number of persons looking for parking, the total probability of vacancy sometimes becomes lower than the total probability of usage when the value of “n” is less than the number of persons looking for parking. Therefore, in the third embodiment, the value of “n” is set to all natural numbers of the number of persons looking for parking or less and the processor 24 compares the total probability of vacancy and the total probability of usage at all values of “n” to judge whether the group of private parking spaces can be reserved for a predetermined time slot.

Specifically, the processor 24 calculates the total probability of vacancy and the total probability of usage for each of the values of “n”. Further, the processor 24 accepts reservation of the group of private parking spaces for a predetermined time slot from a person looking for parking only if the total probability of vacancy minus the total probability of usage is equal to or more than a reference value at all of the values of “n”. By doing this, it is possible to keep utilization of parking spaces by owners and persons looking for parking from being hindered much more.

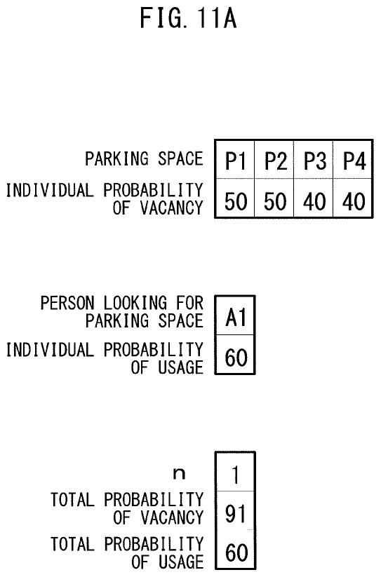

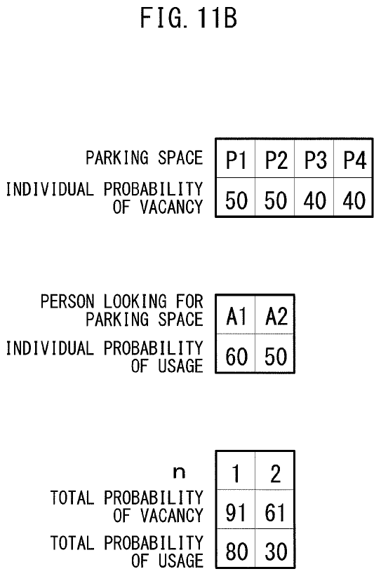

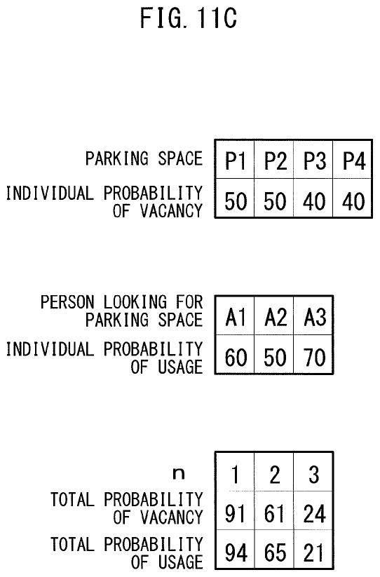

FIG. 11A to FIG. 11C show specific examples in the third embodiment of comparing the total probability of vacancy and the total probability of usage to judge whether the group of private parking spaces can be reserved. In the examples of FIG. 11A to FIG. 11C, in the same way as the examples of FIG. 3A to FIG. 3D, the group of private parking spaces includes four parking spaces P1 to P4. Further, the individual probabilities of vacancy of the parking spaces P1 to P4 are respectively 50%, 50%, 40%, and 40%. Note that, in the examples of FIG. 11A to FIG. 11C, to simplify the explanation, it is assumed that the individual probabilities of vacancy are maintained constant.

In the example of FIG. 11A, first, a person looking for parking A1 requests to reserve the group of private parking spaces for a predetermined time slot. The processor 24 calculates the individual probability of usage for the person looking for parking A1 based on the second information relating to the person looking for parking A1. In this example, the individual probability of usage for the person looking for parking A1 is 60%.

In the example of FIG. 11A, there is a single person looking for parking, so the value of “n” used for calculating the total probability of vacancy and the total probability of usage becomes 1. In this example, the total probability of vacancy when “n” is 1, that is, the probability of one or more parking spaces not being utilized by their owners for a predetermined time slot, is 91%. Further, the total probability of usage when “n” is 1 , that is, the probability of one or more persons looking for parking utilizing the group of private parking spaces for predetermined time slot, is 60%.

Therefore, when “n” is 1, the total probability of vacancy (91%) is higher than the total probability of usage (60%). In the examples of FIG. 11A to FIG. 11C as well, the reference value for judging whether the group of private parking spaces can be reserved is set to zero. That is, if the total probability of vacancy is equal to or more than the total probability of usage, reservation of the group of private parking spaces is accepted. For this reason, reservation of the group of private parking spaces is accepted from the person looking for parking A1.

In the example of FIG. 11B, a person looking for parking A1 reserves the group of private parking spaces, then a person looking for parking A2 requests to reserve the group of private parking spaces for a predetermined time slot. The person looking for parking A1 still is not utilizing the group of private parking spaces. Note that, in the examples of FIG. 11A to FIG. 11C as well, for simplification of the explanation, it is assumed that the individual probabilities of usage of persons looking for parking are maintained constant. The processor 24 calculates the individual probability of usage for the person looking for parking A2 based on the second information relating to person looking for parking A2. In this example, the individual probability of usage for the person looking for parking A2 is 50%.

In the example of FIG. 11B, there are two persons looking for parking, so the values of “n” used for calculating the total probability of vacancy and the total probability of usage becomes 1 and 2. In this example, the total probability of vacancy when “n” is 1, that is, the probability of one or more parking spaces not being utilized by their owners for a predetermined time slot, is 91%. Further, the total probability of usage when “n” is 1, that is, the probability of one or more persons looking for parking utilizing the group of private parking spaces for a predetermined time slot, is 80%. Therefore, when “n” is 1, the total probability of vacancy (91%) is higher than the total probability of usage (80%).

In this example, the total probability of vacancy when “n” is 2, that is, the probability of two or more parking spaces not being utilized by their owners for a predetermined time slot, is 61%. Further, the total probability of usage when “n” is 2, that is, the probability of two or more persons looking for parking utilizing the group of private parking spaces for a predetermined time slot, is 30%. Therefore, when “n” is 2, the total probability of vacancy (61%) is higher than the total probability of usage (30%). In this example, the total probability of vacancy is equal to or more than the total probability of usage at all of the values of “n”, so reservation of the group of private parking spaces is accepted from the person looking for parking A2.

In the example of FIG. 11C, persons looking for parking A1 and A2 reserve the group of private parking spaces, then the person looking for parking A3 requests to reserve the group of private parking spaces for a predetermined time slot. The persons looking for parking A1 and A2 have still not utilized the group of private parking spaces. The processor 24 calculates the individual probability of usage for the person looking for parking A3 based on the second information relating to the person looking for parking A3. In this example, the individual probability of usage for the person looking for parking A3 is 70%.

In the example of FIG. 11C, there are three persons looking for parking, so the values of “n” used for calculating the total probability of vacancy and the total probability of usage are 1, 2, and 3. In this example, the total probability of vacancy when “n” is 1, that is, the probability of one or more parking spaces not being utilized by their owners for a predetermined time slot, is 91%. Further, the total probability of usage when “n” is 1, that is, the probability of one or more persons looking for parking utilizing the group of private parking spaces for a predetermined time slot, is 94%. Therefore, when “n” is 1, the total probability of vacancy (91%) is lower than the total probability of usage (94%).

In this example, the total probability of vacancy when “n” is 2, that is, the probability of two or more parking spaces not being utilized by their owners for a predetermined time slot, is 61%. Further, the total probability of usage when “n” is 2, that is, the probability of two or more persons looking for parking utilizing the group of private parking spaces for a predetermined time slot is 65%. Therefore, when “n” is 2, the total probability of vacancy (61%) is lower than the total probability of usage (65%).

In this example, the total probability of vacancy when “n” is 3, that is, the probability of three or more parking spaces not being utilized by their owners for a predetermined time slot, is 24%. Further, the total probability of usage when “n” is 3, that is, the probability of three or more persons looking for parking utilizing the group of private parking spaces for a predetermined time slot is 21%. Therefore, when “n” is 3, the total probability of vacancy (24%) is higher than the total probability of usage (21%). In this example, when “n” is 1 or 2, the total probability of vacancy is lower than the total probability of usage, so reservation of the group of private parking spaces is rejected.

<Processing for Judgment of Reservation>

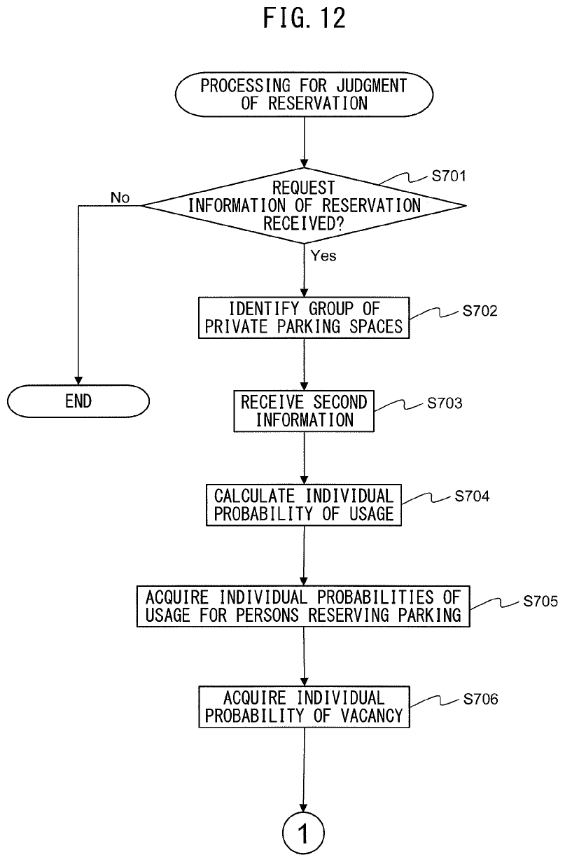

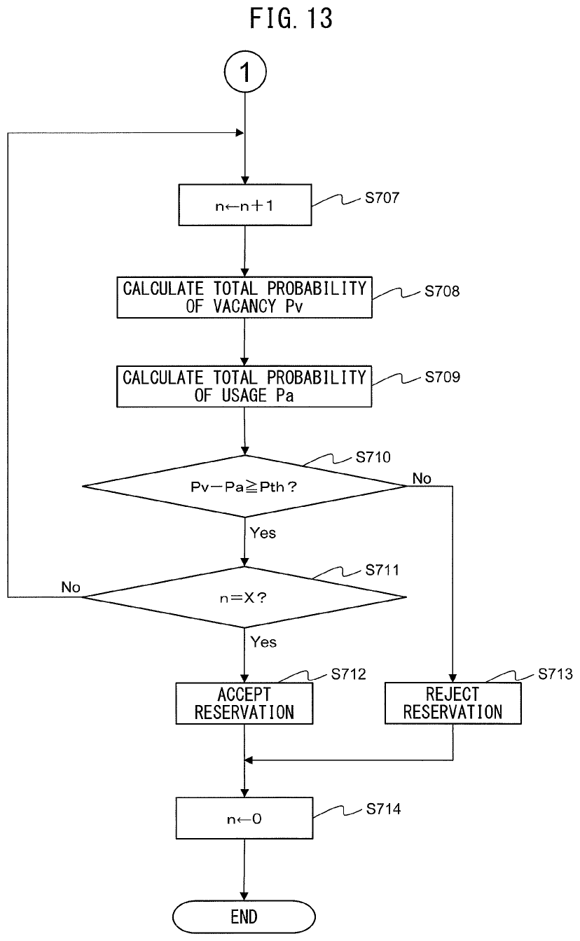

FIG. 12 and FIG. 13 show a flow chart showing a control routine of processing for judgment of a reservation in the third embodiment. The present control routine is repeatedly executed by the processor 24 of the server 2. Step S701 to step S706 are similar to step S401 to step S406 of FIG. 8, so explanations will be omitted.

In the present control routine, after step S706, at step S707, the processor 24 adds 1 to “n”. Note that, the initial value of “n” is zero.

Next, at step S708, the processor 24 calculates the total probability of vacancy Pv when a predetermined time slot is the desired time slot based on the individual probability of vacancy acquired at step S706. That is, the processor 24 calculates the probability of “n” or more of parking spaces not being utilized by the owners at the desired time slot. Note that, if “n” is larger than the number of parking spaces of the group of private parking spaces, the total probability of vacancy Pv becomes 0%.

Next, at step S709, the processor 24 calculates the total probability of usage Pa when a predetermined time slot is the desired time slot based on the individual probability of usage calculated at step S704 and the individual probability of usage acquired at step S705. That is, the processor 24 calculates the probability of “n” or more persons looking for parking utilizing the group of private parking spaces for the desired time slot.

Next, at step S710, the processor 24 judges if the total probability of vacancy Pv minus the total probability of usage Pa is a reference value Pth or more. The reference value Pth is determined in advance and is for example zero. If the reference value Pth is zero, at step S710, the processor 24 judges whether the total probability of vacancy Pv is equal to or more than the total probability of usage Pa.

If at step S710 it is judged that the value of the total probability of vacancy Pv minus the total probability of usage Pa is less than the reference value Pth, the present control routine proceeds to step S713. At step S713, the processor 24 rejects the reservation of the group of private parking spaces from the person looking for parking. Specifically, the processor 24 sends a notification of rejection to the second terminal 4 of the person looking for parking through the communication interface 21 and communication network 5.

On the other hand, if at step S710 it is judged that the total probability of vacancy Pv minus the total probability of usage Pa is equal to or more than the reference value Pth, the present control routine proceeds to step S711. At step S711, the processor 24 judges whether “n” is equal to the number of persons looking for parking X.

If at step S711 it is judged that “n” is different from the number of persons looking for parking X, the present control routine returns to step S707. On the other hand, if at step S711 it is judged that “n” is equal to number of persons looking for parking X, the present control routine proceeds to step S712. In this case, the total probability of vacancy and the total probability of usage for each of the values of “n” are calculated and it is judged that the total probability of vacancy Pv minus the total probability of usage Pa is equal to or more than the reference value at all of the values of “n”.

Therefore, at step S712, the processor 24 accepts reservation of the group of private parking spaces from the person looking for parking. Specifically, the processor 24 sends a notification of allowance to the second terminal 4 of the person looking for parking through the communication interface 21 and communication network 5. After step S712 or step S713, at step S714, the processor 24 resets “n” to zero. After step S714, the present control routine ends.

Above, preferred embodiments according to the present invention were explained, but the present invention is not limited to these embodiments. Various corrections and changes may be made within the language of the claims.

### REFERENCE SIGNS LIST

1 parking space rent-out system
2 server (parking space rent-out apparatus)
21 communication interface
24 processor
3 first terminal
4 second terminal

1. A parking space rent-out apparatus for renting out a group of private parking spaces having a plurality of parking spaces within a predetermined range and with different owners to a person looking for parking, comprising
a communication device able to receive first information sent through a first terminal owned by an owner and second information sent through a second terminal owned by the person looking for parking and
a control device, wherein
the control device is configured to calculate for each of the plurality of parking spaces an individual probability of vacancy which is a probability of the parking space not being utilized by its owner for a predetermined time slot based on the first information, calculate for each of the persons looking for parking an individual probability of usage which is a probability of the person looking for parking using the group of private parking spaces for the predetermined time slot based on the second information, calculate a total probability of vacancy which is a probability of “n” or more parking spaces not being used by their owners for the predetermined time slot based on the individual probabilities of vacancy, calculate a total probability of usage which is a probability of “n” or more persons looking for parking using the group of private parking spaces for the predetermined time slot based on the individual probabilities of usage, and accept a reservation of the group of private parking spaces for the predetermined time slot from a person looking for parking only if the total probability of vacancy minus the total probability of usage is equal to or more than a reference value, and
a value of “n” includes a natural number of the number of persons looking for parking or less.

2. The parking space rent-out apparatus according to claim 1, wherein the value of “n” is set to the number of persons looking for parking.

3. The parking space rent-out apparatus according to claim 1, wherein
the value of “n” is set to all natural numbers of the number of persons looking for parking or less, and
the control device is configured to calculate for each of the values of “n” the total probability of vacancy and the total probability of usage and accept a reservation for the group of private parking spaces for the predetermined time slot from a person looking for parking only if the total probability of vacancy minus the total probability of usage is equal to or more than the reference value at all of the values of “n”.

4. The parking space rent-out apparatus according to claim 1, wherein after a vehicle of a person looking for parking allowed to reserve the group of private parking spaces arrives in the vicinity of the group of private parking spaces, the control device is configured to notify the person looking for parking about one available parking space in the group of private parking spaces through the second terminal.

5. The parking space rent-out apparatus according to claim 1, wherein if the group of private parking spaces is not available when a vehicle of a person looking for parking allowed to reserve the group of private parking spaces arrives in the vicinity of the group of private parking spaces, the control device is configured to guide the vehicle of the person looking for parking to a parking space other than the group of private parking spaces through the second terminal.

6. The parking space rent-out apparatus according to claim 1, wherein if an owner's parking space is being utilized by a person looking for parking when a vehicle of the owner returns to the owner's parking space, the control device is configured to guide the vehicle of the owner to a parking space other than the owner's parking space through the first terminal.

7. The parking space rent-out apparatus according to claim 1, wherein the first information includes a current position of a vehicle of the owner.

8. The parking space rent-out apparatus according to claim 1, wherein the first information includes a destination of a vehicle of the owner.

9. The parking space rent-out apparatus according to claim 7, wherein if the vehicle of the owner is an electric vehicle, the first information includes a state of charge of a battery provided in the vehicle of the owner.

10. The parking space rent-out apparatus according to claim 8, wherein if the vehicle of the owner is an electric vehicle, the first information includes a state of charge of a battery provided in the vehicle of the owner.

11. The parking space rent-out apparatus according to claim 1, wherein the first information includes information relating to a schedule of the owner.

12. The parking space rent-out apparatus according to claim 1, wherein the second information includes a current position of a vehicle of the person looking for parking.

13. The parking space rent-out apparatus according to claim 1, wherein the second information includes a destination of a vehicle of the person looking for parking.

14. The parking space rent-out apparatus according to claim 12, wherein if the vehicle of the person looking for parking is an electric vehicle, the second information includes a state of charge of a battery provided in the vehicle of the person looking for parking.

15. The parking space rent-out apparatus according to claim 13, wherein if the vehicle of the person looking for parking is an electric vehicle, the second information includes a state of charge of a battery provided in the vehicle of the person looking for parking.

16. The parking space rent-out apparatus according to claim 1, wherein the second information includes information relating to a schedule of the person looking for parking.

17. A parking space rent-out system for renting out a group of private parking spaces having a plurality of parking spaces within a predetermined range and with different owners to a person looking for parking, comprising
a first terminal able to send first information relating to an owner, a second terminal able to send second information relating to a person looking for parking, and a server, wherein
the server comprises
a communication device able to receive the first information and the second information and
a control device, and
the control device is configured to calculate for each of the plurality of parking spaces an individual probability of vacancy which is a probability of the parking space not being utilized by its owner for a predetermined time slot based on the first information, calculate for each of the persons looking for parking an individual probability of usage which is a probability of the person looking for parking using the group of private parking spaces for the predetermined time slot based on the second information, calculate a total probability of vacancy which is a probability of “n” or more parking spaces not being used by their owners for the predetermined time slot based on the individual probabilities of vacancy, calculate a total probability of usage which is a probability of “n” or more persons looking for parking using the group of private parking spaces for the predetermined time slot based on the individual probabilities of usage, and accept a reservation of the group of private parking spaces for the predetermined time slot from a person looking for parking only if the total probability of vacancy minus the total probability of usage is equal to or more than a reference value, and
a value of “n” includes a natural number of the number of persons looking for parking or less.

18. A parking space rent-out method for renting out a group of private parking spaces having a plurality of parking spaces within a predetermined range and with different owners to a person looking for parking, comprising
receiving first information sent through a first terminal owned by an owner,
receiving second information sent through a second terminal owned by the person looking for parking,
calculating for each of the plurality of parking spaces an individual probability of vacancy which is a probability of the parking space not being utilized by its owner for a predetermined time slot based on the first information,
calculating for each of the persons looking for parking an individual probability of usage which is a probability of the person looking for parking using the group of private parking spaces for the predetermined time slot based on the second information,
calculating a total probability of vacancy which is a probability of “n” or more parking spaces not being used by their owners for the predetermined time slot based on the individual probabilities of vacancy,
calculating a total probability of usage which is a probability of “n” or more persons looking for parking using the group of private parking spaces for the predetermined time slot based on the individual probabilities of usage, and
accepting a reservation of the group of private parking spaces for the predetermined time slot from a person looking for parking only if the total probability of vacancy minus the total probability of usage is equal to or more than a reference value,
the value of “n” including a natural number of the number of persons looking for parking or less.
